(19) United States
(12) Patent Application Publication
(10) Pub. No.: US 2021/0077890 A1
(43) Pub. Date: Mar. 18, 2021

(54) SIX FINGER SPORTS GLOVE

(71) Applicant: Robert Chorne, Baldwin Harbor, NY (US)

(72) Inventor: Robert Chorne, Baldwin Harbor, NY (US)

(21) Appl. No.: 17/022,031

(22) Filed: Sep. 15, 2020

Related U.S. Application Data
(60) Provisional application No. 62/973,094, filed on Sep. 16, 2019.

(51) Int. Cl. A63B 71/14; A63B 69/00; G09B 19/00

(52) U.S. Cl. CPC A63B 71/146; A63B 2102/32; G09B 19/0038; A63B 69/0059

(57) ABSTRACT

A six fingered glove, for sports, such as, but not limited to, golf promotes the stable grip for a grip of a golf club handle. The glove includes a hand-insertable open proximal wrist portion connected to front palm and dorsal back portions. The glove has a distal array of open finger portions, a first open thumb portion and a second open thumb receiver portion positioned on the front of the palm portion. The second open thumb receiver portion is separated and spaced apart from the first open thumb portion, forming the six fingered glove, whereby the thumb and four fingers of one hand of the wearer are inserted into the first open thumb portion and the open finger portions, and the thumb of the wearer's other hand is inserted into the second open thumb receiver portion of the glove, thereby stabilizing the wearer's manual grip of the golf club handle.

### RELATED APPLICATIONS

This application claims benefit pursuant to 35 U.S.C. § 119 (e) of provisional patent application Ser. No. 62/973,094, filed Sep. 16, 2019. The '094 application is incorporated by reference herein.

### FIELD OF THE INVENTION

The present invention relates to sports apparatus and equipment, and uses thereof, used in playing the game of various sports. The present invention and its glove embodiments enhance the overall performance in athletic tasks and/or execution commonly associated during sports play, particularly in, but not limited to golf by configuring to meet the specific requirements of a user who plays the sport of golf. The present invention's unique configurations generally enclose the thumb as well as the forefinger, middle, ring and pinkie fingers of a user's hand, including the fingertips. Furthermore, these gloves comprise an additional receiver portion for the opposite hands thumb portion, on the palm side of the golf glove thereby creating an enhancing means on the palm portion of the glove, for the user grip for the golf club. Embodiments may also provide a grip enhancing means along select segments of the palmar portion, including but not limited to, along the thumb segment's palmar portion.

### BACKGROUND OF THE INVENTION

An important goal in playing sports is to play as well as one can. Often that means proper play execution, good ball control, good grip and feel, and proper form in the sports fundamentals. Gloves and other types of hand covers are permitted in most sports. Many individuals use gloves to enhance, in some way, their competitive edge. Indeed, gloves have become so important that different types of gloves have been uniquely created for different sports. Even within a sport, different types of gloves have been invented to, among other things, maximize performance in specific tasks.

The use of gloves can increase performance especially when the user needs to grip an object like a golf club, for example. When playing the sport of Golf this ability to create and maintain a solid grip is critical when swinging a golf club especially since, when one prepares to swing the golf club, he (or she) must use his hands both to grip as well as ‘feel’ the golf club throughout the golf swing.

This ability to both grip and feel is important when swinging a golf club. Once a golfer begins to swing a golf club, the golfer must use tactile sensations to feel if the golf club is on the correct swing plane throughout the golf swing.

The use of gloves in golf however is critical as most golf pros will agree, the most important factor in a good golf swing is the ability to have a solid grip on the golf club, a good golf grip. It is the fundamental keystone to a good golf swing.

Thus, golfers have generally decided to wear only one glove, on their weak hand, thereby increasing the overall grip of the weak hand golf glove and thus foregoing a glove on their strong (dominant) hand to compensate for the loss of tactile sensation from wearing a glove on their weak-hand.

Conventional golf gloves are generally full fingered leather gloves, many with a grip enhancing surface on the palmar portion of these gloves. Some of these gloves also provide elastic inserts along the knuckles for added flexibility or micro recesses along the finger segments of the back portion of these gloves.

Although generally useful, using prior art conventional golf gloves can come with significant drawbacks for one to learn the connection of the hands throughout the swing, especially because a user must use his or her hands as one cohesive unit throughout a golf swing.

Several authorities have cited the importance of the golfer's two hands forming a cohesive structural unit along the golf club, so they can function as a single club-gripping agent (from the ‘Grip’ webpage of PERFECTGOLFSWINGREVIEW, for example). This is so important that the two most popular golf grip methods, the interlocking grip method and the overlapping grip method, place the hands right next to each other to better create this unitary hand golf swing.

As will be discussed, prior art gloves are not configured to support this desire to unify the golfer's two hands, and many gloves actually hinder achieving this objective.

A case in point of prior art limitations occurs, for example, when a golfer desires to swing the golf club with significant velocity.

Quite often a golfer's success requires swinging the golf club in a manner to produce significant club speed, especially when teeing off at the beginning of each hole. As the velocity of the golf club increases, it becomes increasingly more difficult to maintain a firm, though not tight, grip connection on the club; this is especially true on the downswing through the point of impact with the golf ball. Consider the fact that the average clubhead speed of all competitors in the RE/MAX Golf World Long Drive Competition was well over 100 miles per hour; these golfers especially rely on a good grip to control the golf club so that the club face will be square at impact with the golf ball.

Prior art shortcomings create a challenge to have a consistent swing, especially when swinging a golf club at these high speeds. Clearly, one reason for this has to do with not sustaining the ability to keep one's hands together throughout the golf swing, especially when transitioning from the backswing to the downswing, as well as at—and through—impact with the golf ball. The result, of course, has often resulted in several problems such as: difficulty in weak-hand and dominant hand coordination because one hand unhinges quicker than the other hand; difficulty in being able to control the golf club face through impact, and; the dominant hand and weak hand separate during the swing. As a consequence, the golf club face may not be square at impact, resulting in a slice or hook.

However, no improvements have been made to increase the connection of the lead thumb into the opposite hands thumb pad region, which is a vital ingredient to maximizing overall hand coordination and golf swing.

An additional major drawback of prior art has to do with a lack of grip connection in the playing position coordinating the hands throughout the golf swing.

Embodiments of the present invention will certainly find success using any traditional gripping method, interlocking, overlapping or ten finger grip methods.

Many golfers choose the interlocking grip instead of the Overlapping Grip Method because they desire greater unity in their golf swing, because they have relatively smaller hands, or because they have weaker hands and need added grip. Thus, providing even greater grip potential for those using the interlocking grip method, as the present invention provides, would certainly be welcome. A common reason player choose one grip over another is their desire to create unity between their hands. When a player swings his or her club, the player's wrists act as a hinge. However, if the player's hands become separated during the swing, each wrist can act separately, and the player's opposite hands can interfere with each other.”

### OBJECTS OF THE INVENTION

There is therefore a long existing need for a glove that can offer better hand coordination between a golfer's strong hand and weak hand without significantly diminishing a golfer's ability to adequately grip the golf club.

An ideal location to minimize hand separation is clearly around and between the two interlocked fingers in the case of the interlocked method, or around and between the overlapped fingers, in the case of the overlapped method.

Consequently, users with prior art golf gloves will have an unstable connection of the lead thumb to the pad on the opposite hand, especially when dealing with moisture through harsh climate or from perspiration on the palm of the thumb of the lead hand or the palm of the opposite hand.

When a golfer hits off line missing the target, for example, the golf ball flies to the far off the intended line of flight because the hands separated during the swing and caused the face to come into the ball either open or closed.

Embodiments of the present invention would therefore offer significant improvements to prior art by offering strategically placed second thumb receiver, thereby connecting the hands from set up throughout the swing for more control. The result will significantly enhance a golfer's golf swing success by better allowing the two hands to have a coordinated, unified golf swing.

More broadly, providing a more strategic grip management system will create a firmer contact between the thumb of the lead hand and the pad on the opposite hand palm side, therefore a more controlled golf swing for those using the interlocking, overlapping or ten finger grip methods.

Solving this unrecognized problem, as embodiments of the present invention provide, will significantly enhance consistent connection of the hands throughout the golf swing thereby providing more control, especially as a golfer begins the swing with a better connection and throughout the swing at the fast speeds the game requires.

Providing a solution to better solve these issues could, among other things, allow for greater golf swing control and consistency by providing a golfer with significantly enhanced support for a golfer's hand grip and coordination requirements.

The present invention solves the abovementioned problems by, among other things, providing significant improvements to grip support on critical areas on or around the lead thumb connection to the opposite hands palm side.

### SUMMARY OF THE INVENTION

In keeping with the aforesaid objects and goals of the invention, the present invention is preferably a six fingered glove, for sports, such as, but not limited to, golf. The glove, which promotes the stable grip of a golf club handle, includes a front palm portion and a rear dorsal portion. The glove also has a hand-insertable open proximal wrist portion and a distal array of open finger portions, a first open thumb portion and a second open thumb receiver portion. The second open thumb receiver portion is positioned on the aforementioned front palm portion. The second open thumb receiver portion is separated and spaced apart from the first open thumb portion, forming a six fingered glove, whereby the thumb and four fingers of one hand of the wearer are inserted into the first open thumb portion and the open finger portions, and the thumb of the wearer's other hand is inserted into the second open thumb receiver portion of the glove, thereby stabilizing the wearer's manual grip for the golf club handle.

While the second open thumb receiver portion is preferably spaced apart and adjacent to the first open thumb portion, in one embodiment it is actually next to the first open thumb portion. It may also be positioned below and to the side of the first open thumb portion, on the front surface of the palm portion, opposite to where a closure flap is located on the reverse rear portion of the palm portion.

The second open thumb receiver portion receives and secures the thumb of the wearer's other hand to the glove. It may take the form of being a closed thumb stall sleeve, an open-ended sleeve, a partial length sleeve, or one or more loops recurring the thumb of the player's other hand to the glove.

The second open thumb receiver portion is either permanently attached to the glove, by stitching or by adhesive, or may be removably attached to a location on the front surface of the palm portion of the glove, by removable fasteners, such as VELCRO® hook and loop fasteners, snaps, buttons, or tape.

The second thumb receiver portion may optionally be texturized with projections or other surface gripping enhancement textured units.

The second thumb receive portion may also be attached to removably attachable inserts, which are removably affixed to the glove surface by forming a grip enhancing panel and applying the panel onto a portion of the glove, wherein the second thumb receiver portion is removably affixed to a grip enhancing panel located on a portion of the front surface of the palm portion of the glove.

The second thumb receiver may optionally be made of a stretchable fabric which is stretchable in axial length and/or diameter width, for the comfort of the player wearing the six-finger glove.

Preferably the second thumb receiver is made of a material selected from the group consisting of natural, leather, synthetic leather, rubber material, elastic material, knitted fabric, LYCRA®, wood cellulose based Rayon fabric, cotton, natural, synthetic or blends of natural and synthetic yarns, thermo-extruded material, thermoset rubbery material, thermoplastic elastomers, synthetic yarns, nylon, polyester, polyurethane yarns, SPANDEX®, stretchable fabric, mesh fabrics, recycled and flexible materials, cottons, polyester, fleece, rubbers, plastics, woven fabrics, non-woven fabrics, cloths, LYCRA, vinyl materials, NEOPRENE®Ms a neoprene material, COOL MAX® fabric, or wicking materials to wick moisture away form a user's skin, natural rubber latex, synthetic rubber nitrile, polyvinyl alcohol material, polyvinyl chloride, polyethylene, polyurethane, polyester/cotton blends, polyolefin fibers, or combinations thereof.

In use, the six-finger glove can be used in a method of training a player to stabilize and hold his or her hands upon a golf club handle prior to swinging the golf club for striking a golf ball while engaged in a golf sports activity, including the following steps of comprising the steps of:

providing the player with a glove having an open proximal wrist portion, a front palm portion and a back dorsal portion, said glove having a distal array of open finger portions and a first open thumb portion,

providing a second open thumb receiver portion to be positioned on said front palm portion, said second open thumb receiver portion being separated and spaced apart from said first open thumb portion,

forming a six fingered glove, whereby the thumb and four fingers of one hand of the wearer are inserted into the first open thumb portion and said open finger portions, and the thumb of the wearer's other hand is inserted into said second open thumb receiver portion of the glove, thereby stabilizing the wearer's manual grip of the golf club handle; and,

instructing the player to maintain said two-thumbed grip upon the golf club handle during the entire swinging of the golf club and striking the golf ball during the swinging of the golf club; and instructing the player to use his or her hands both to grip as well as feel the golf club throughout the golf swing, whereby the handle of the golf club is stabilized prior to striking the golf ball, during the striking of the golf ball and during the follow-through portion of the player's swinging of the golf club.

As a result, the player's hands do not separate during swinging of the golf club, thereby connecting the hands together during the entire golf swing, from set up throughout the swing for more control. The result significantly enhances a golfer's golf swing success by better allowing the two hands to have a coordinated, unified golf swing.

The present invention also includes a method of training a player to stabilize and hold his or her hands in a golf grip position while engaged in a golf sports activity, comprising the steps of:

providing the player with a glove having an open proximal wrist portion connected to a front palm portion and a back dorsal portion, said glove having a distal array of open finger portions and a first open thumb portion,

providing a second open thumb receiver portion to be positioned on said front palm portion, said second open thumb receiver portion being separated and spaced apart from said first open thumb portion,

forming a six fingered glove, whereby the thumb and four fingers of one hand of the wearer are inserted into the first open thumb portion and said open finger portions, and the thumb of the wearer's other hand is inserted into said second open thumb receiver portion of the glove, thereby stabilizing the wearer's manual grip for the golf grip position; and,

instructing the player to maintain said two-thumbed grip in a golf grip position.

### BRIEF DESCRIPTIONS OF THE DRAWING

It is expressly understood that the following descriptions and drawings are for illustration purposes only, and in no way are intended to limit the scope of the present invention and its various embodiments. For example, the drawings are of embodiments for the Right hand but can easily be created for the left hand.

FIG. 1 is a perspective view of a golfer who is wearing the inventive glove while addressing the ball during a training session.

FIG. 2 is a front perspective view of the inventive glove with the attached thumb stall, taken at view arrow 2 of FIG. 1.

FIG. 3 is a front perspective view of the inventive glove, illustrating how the thumb of the free hand is received into the stall.

FIG. 4 is a perspective view, similar to FIG. 3, but illustrating how the gripping of a club is improved by the use of the inventive glove.

FIG. 5 is a perspective view of a first alternate embodiment, wherein the thumb securement means for the thumb of the free hand comprises a long, tubular sleeve.

FIG. 6 is a perspective view of a second alternate embodiment, wherein the thumb securement means for the thumb of the free hand comprises a short, tubular sleeve.

FIG. 7 is a perspective view of a third alternate embodiment, wherein the thumb securement means for the thumb of the free hand comprises two loops.

FIG. 8 is a perspective view of a fourth alternate embodiment, wherein the thumb securement means for the thumb of the free hand is removably attachable to the palm portion of the glove.

### DETAIL DESCRIPTIONS OF THE INVENTION

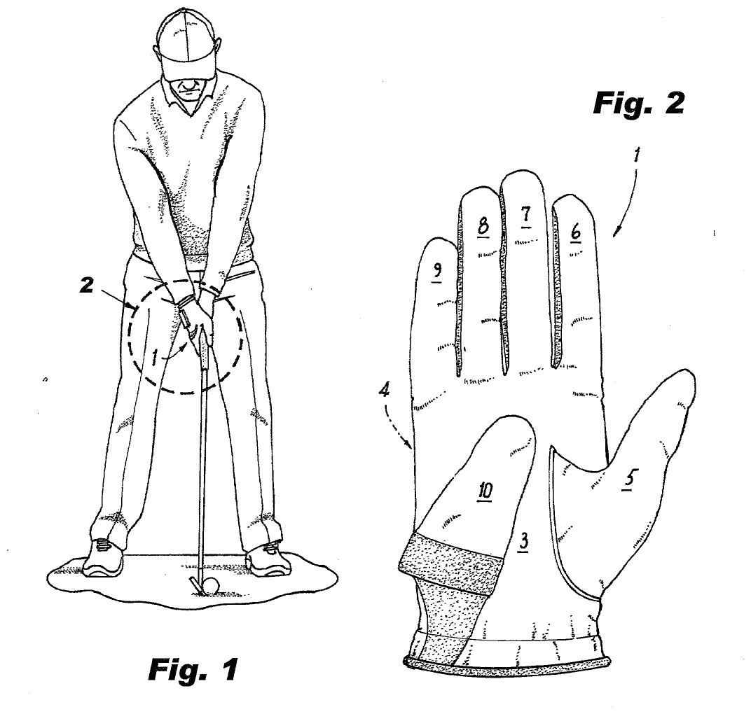

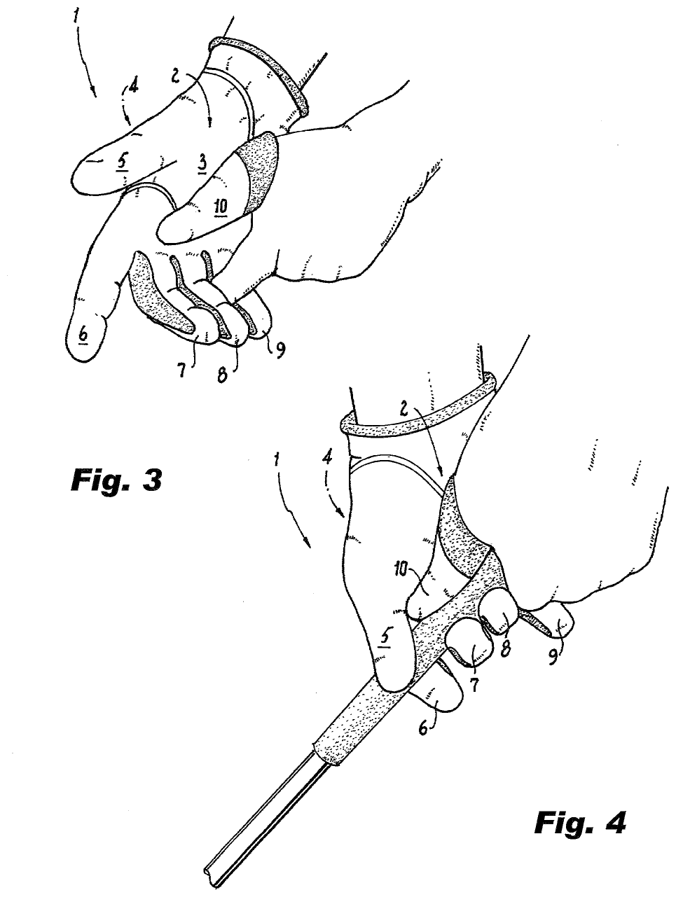

As shown in FIGS. 1-4, the present invention provides a glove 1 having a palm portion 2, with a front palm facing surface 3 and an opposite rear dorsal (back) surface 4, for overlaying respective back and palm regions of a human hand. The palm portion 2 has distal and proximal ends with a plurality of digital segments (or stalls) 5, 6, 7, 8 and 9, projecting from the distal end of the palm portion 2. The digital segment 5 of the thumb covers the thumb generally including the fingertip of the thumb of a user. The digital segment 6 of the forefinger covers the forefinger including generally the fingertip of the forefinger of a user and the digital segment 7 of the middle finger covers the middle finger including generally the fingertip of the middle finger of a user The digital segment 8 of the ring finger covers generally the ring finger including the fingertips of the ring finger of a user, and the digital segment 9 of the pinkie finger covers the pinkie finger including generally the fingertip of the pinkie finger of a user.

An improvement of this golf glove includes a grip enhancing means, comprising a second thumb receiver 10 located on the front of the palm portion 2 of the six-finger glove 1. While other positional locations of the second thumb receiver 10 may vary, in one preferred aspect, the second thumb receiver 10 on the palm portion 2 of the glove 1, is preferably below, and spaced apart from, the first thumb digital segment stall portion 5.

In another embodiment, as a grip enhancing means, the second thumb receiver portion 10 of the glove 1 on the palm side portion 2, is spaced apart from the first thumb portion 5 in other locations on the front surface 3 of the palm portion 2 of the glove 1.

For example, the grip enhancing second thumb receiver portion 10 may be provided on the front side surface 3 of the palm portion 2 of the glove 1 to allow the connection of the lead thumb of the player user to the palm portion 2 of the opposite hand.

Preferably, at least a portion of the lead thumb will be located at the location of the second thumb receiver portion 10, grip enhancing means, thereby providing substantially enhanced grip capabilities with swinging a golf club, by providing significant added grip connection between the opposite hand lead thumb 10 and the palm side portion 2 of the opposite hand.

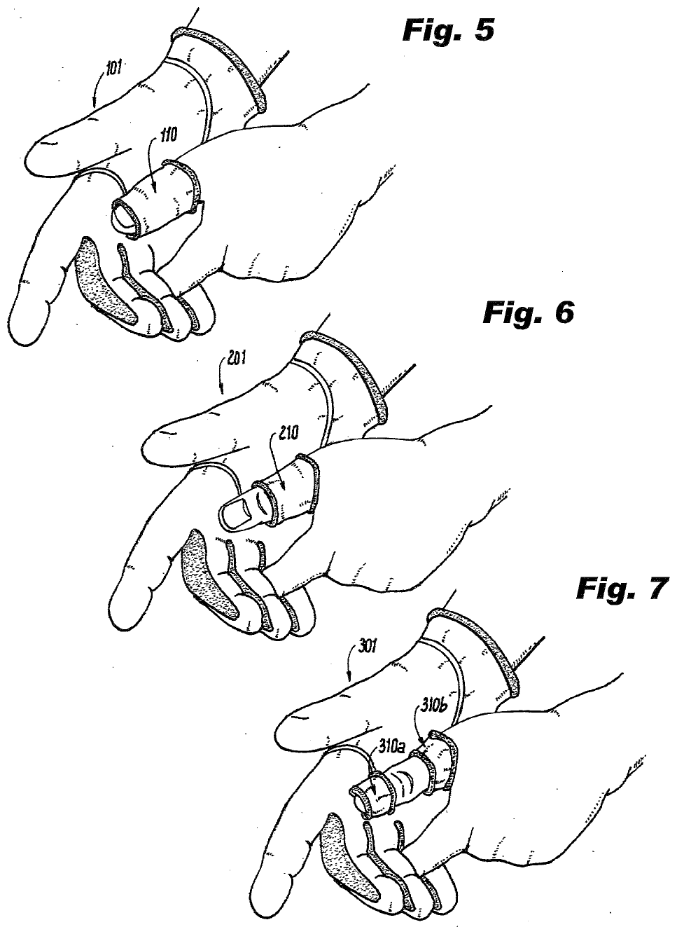

In an alternate embodiment shown in FIG. 5, the second thumb receiver portion of the glove 101 is an open sleeve portion 110.

In a further alternate embodiment shown in FIG. 6, the second thumb receiver portion of the glove 201 is a partial length open thumb sleeve portion 210.

In yet another alternate embodiment shown in FIG. 7, the second thumb receiver portion of the glove 301 includes one or more second thumb receiver loops 319a and 310b grasping the second thumb to the glove 10.

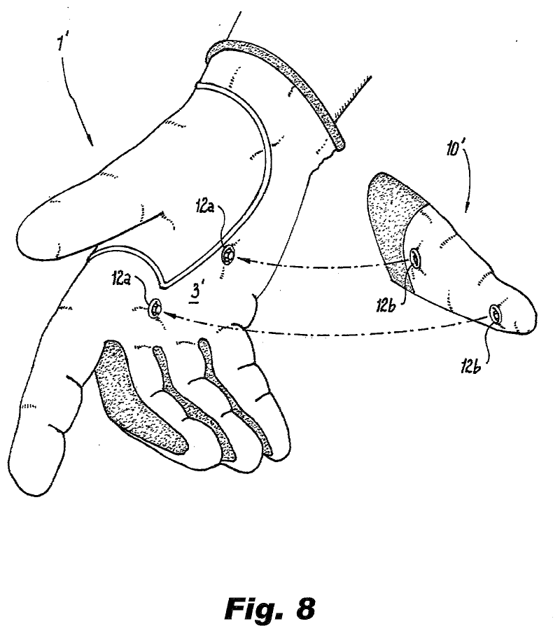

Other embodiments may also comprise a second thumb receiver portion 10, 110, 210 or 310a and 310b, as a grip enhancing means that may be removably attachable and removable from and to the glove 10. For example, FIG. 8 shows a glove 1′, where the thumb securement receiver 10′ for the thumb of the free hand is removably attachable to the palm portion 3′ of the glove 1′ with fasteners, such as male snap fasteners 12a engageable with female snap fasteners 12b. While pairs of snap fasteners 12a, 12b are shown in FIG. 8, it is contemplated that other fasteners may be employed, such as hook and loop fasteners (VELCRO®), double-sided adhesive tape, magnets, buttons and buttonhole slits, buckles, turn locks, swivel locks, zippers, etc.

Other further embodiments may include a second thumb receiver grip enhancing second thumb receiver portion 10, 110, 210 or 310a, 310b that can accommodate various length and sizes of thumbs of player users by being stretchable in axial length and or width diameter.

Another objective is to provide improved golf gloves whereby some embodiments may be configured to meet the unique needs of those employing the interlocking grip method, while other embodiments may meet the unique needs of those employing the overlapping grip method and or ten finger grip method.

Accordingly, embodiments provide a novel glove that takes into account a user's preferred golf grip, thereby creating a significantly more stable, solid connection between the hands throughout a golfer's swing.

The second thumb receiver portion 10, 110, 210, 310a/310b grip enhancing means can therefore be specifically positioned to provide enhanced grip and generally a higher coefficient of friction along select areas of the palm side 3 of the palm portion 2, between the lead thumb and opposite palm portion of the glove 1. The second thumb receiver 10 grip enhancing means offers a golfer multiple benefits such as increased control of a ball or device, thereby enhancing performance and overall success at performing a sports task, and providing golfers with the ability to better swing a golf club with more unified hands.

Users of course may prefer any second thumb receiver grip enhancing means combinations aforementioned.

In general, the second thumb receiver portion 10, 110, 210, 310a/310b grip enhancing means of the present invention may be integral to the glove 1, may be in the form of inserts, or may be affixed to the glove surface by, for example, forming a grip enhancing panel and applying the panel onto a portion of the glove. The grip enhancing means of an embodiment could comprise, for example, a high friction textured surface with a more narrow width and length or diameter. This and other embodiments may include a plurality of projections on the surface as the gripping means which is formed from, for example, one of a leather material, a rubber material, elastic material, synthetic leather, any suitable means, creating a grip enhancing second thumb receiver portion 10, 110, 210, 310a/310b for the lead thumb on the front palm side 3 of the palm portion 2 of the glove 1.

The material forming the second thumb receiver portion 10 could then be applied to a palm segment of the front surface 3 of the palm portion 2 of the glove, 1, for example, using any standard bonding methods, such as adhesion or stitching.

The second thumb receiver portion 10 can preferably be provided, for example, on the front palm side 3 of the palm portion 2 of the glove 1 to be a similar size thumb stall as the user's normal glove size, plus or minus several centimeters. The second thumb receiver portion 10, preferably could accept the lead thumb and have the ability to stretch if desired by up to 0.625 inches or more. Furthermore, the second thumb receiver portion 10 may be stretchable in axial length and/or in diameter width.

In general, the second thumb receiver portion 10, and the glove 1, itself, may preferably be formed from leather, synthetic material and or a combination of leather, elastic material, cotton or other fabric, including but not limited to, a knitted fabric, for example, LYCRA, wood cellulose based fabrics, such as Rayon, or the like, natural rubber latex, synthetic rubber nitrile, Neoprene®, polyvinyl alcohol material, polyvinyl chloride, polyethylene, polyurethane, polyester/cotton blends, polyolefin fibers, or combinations thereof. Once the grip enhancing surface on the second thumb receiver has been formed, the second thumb receiver may then be applied to the surface of the glove by any standard methods, such as by stitches or adhesives, for example.

The second thumb receiver portion 10 grip enhancing means can also be formed on glove embodiments by any standard method, for example, by embossing, stamping, or molding a portion of the glove to create the gripping receiving means. For example, the grip receiving enhancing means can comprise a regular thumb receiver portion 10 of, for example, the wearer's size hand in height, but may vary in height depending on preference. The second thumb receiver portion 10, may all be the same height as the other receiver which is spaced apart from the second receiver, thus creating a connection area on the front palm surface 3 of the palm portion 2 of the glove 1. Other embodiments could of course offer different heights, non-uniform heights, and have more shapes for receiving the lead thumb receiver portion 10, thereby forming the glove 1.

The grip enhancing means can also be inserted on the glove 1 by any standard method, for example, by providing a textured fabric component of which the surface inserts are made, and securing this material to the glove by sewing this material to select areas of the glove in place of the glove material.

In general, the second thumb receiver portion 10, with grip connections enhancing means of the present invention creates a higher stability for the lead thumb than the surrounding portion on the hand that would usually be bare or another glove palm without a second thumb receiver portion 10.

Preferably, the second thumb receiver portion 10, being placed on the front palm side 3 of the palm portion 2 of the glove 1, will be very visible and thus can provide continual inspiration or reminder to the wearer.

The grip enhancing means may further comprise multi materials, various thickness, or combination of thicknesses, feels, thus providing comfort and adjustability to the wearer.

Accordingly, the aforementioned various embodiments provide a novel glove with added grip-enhancing features that enhance overall connection between the wearer's hands for more control and sports performance.

Embodiments may also offer a second thumb receiver portion 10, 110, 210, 310a/310b, for the lead thumb, which may be integrally formed on the glove. For example, the second thumb receiver portion 10, 110, 210, 310a/310b, i.e., stall, partial stall or location loops, could be attached to the glove 1 by standard methods, such as by conventional stitching about the palm region or affixing whether permanently or otherwise, about the front palm surface 3 of the palm portion region 2 of the glove 1.

It will be apparent to one of ordinary skill in the art that many other implementations of second thumb receiver portion 10, 110, 210, 310a/310b are possible.

The lead thumb connected to the opposite hand will allow a golfer to increase their overall control of a golf swing.

When the golfer uses the interlocking grip method, overlapping grip or ten fingers grip the objective to a good golf grip is to get the lead thumb into a connected position below the opposite hand thumb pad.

Accordingly, the various embodiments can also provide a novel glove with features that can simultaneously assist a golfer improve hand coordination by allowing the thumb of the lead hand to locate consistently in the same location and maintain the connection throughout the swing.

Embodiments of the grip enhancing six finger glove 1 may also have an expandable opening means at a wrist end adapted to receive the user's hand. This may comprise of a wrist portion with a securement opening means, such as but not limited to a flap which mechanically engages a flap capture mechanism to secure the glove to the user's hand (e.g., a synthetic hook and loop fastening interface which adheres when pressed together, commonly using VELCRO). In this case the flap could overlay a small slit or opening along a portion of the back 4 of the glove 1, to allow the glove 1 to widen when a user places the glove 1 onto the hand. The opening means may comprise of other standard used mechanisms of allowing a user to apply and disengage the glove 1, including but not limited to an elastic band material along the wrist portion, or combinations therebetween.

For example, the wrist portion can be stitched on the glove 1 and be made of an expandable composition whereby the glove expands when being placed on a hand, and then naturally readjusts to fit snugly around the user's wrists.

This and other embodiments may also provide a detachable ball marker, such a circular magnetic disc that attaches to a magnet located on the rear, back surface area of the golf glove 1, for example. The ball marker may be secured by any standard fastening means, such as by magnetism or snap fastening, for example. The back portion of the detachable ball marker as well as the connecting back segment 4 of the glove 1 may both therefore have small magnets. The ball marker may be circular or non-circular in design. Providing a detachable ball marker will make it easier for golfers to mark their golf ball on the golf green.

Embodiments may be made and manufactured using standard materials and methods in developing sports gloves. Materials that can comprise these glove embodiments include, but are not limited to, woven materials such as natural, synthetic or blends of natural and synthetic yarns, thermo-extruded or thermoset rubbery embodiments such as those made from thermoplastic elastomers. Examples of synthetic yarns include nylon, polyester, and spandex (polyurethane) yarns. Embodiments may also comprise stretch materials and designs, mesh fabrics, recycled and flexible materials, cottons, polyester, rayon, spandex, fleece, leathers and synthetic leathers such as cabretta leather, rubbers, plastics, woven fabrics, non-woven fabrics, cloths, LYCRA, a vinyl material, a neoprene material, a fleece material, COOL MAX fabric, or wicking materials to wick moisture away form a user's skin, or combinations thereof.

Many embodiments will generally be constructed with the same or similar materials forming both the palmar and dorsal segments of the glove for the most part. Some embodiments, however, may have the palmar segment formed of a more durable material, such as cabrettea leather, while the dorsal segment may be made of a more elastic material, such as nylon, a LYCRA mesh, wicking materials, or lighter materials that minimize moisture build up.

Construction of the present invention may be accomplished by any standard methods, such as, for example, by designing the dorsal and palm sections to meet along a conjoining lateral edge to define a pocket for receiving the eminence of a user's hand, and sewing said sections together. Other standard methods of construction could certainly be used, of course.

As has been discussed, one sport that will clearly benefit from the present invention is golf. The present invention will meet an unmet need by significantly and substantially improving prior art gloves for the strong hand opposite the lead hand. Prior art does not allow a golfer to take complete advantage of his or her preferred grip because they are not configured allow the lead thumb be connected to the palm side of the opposite hand in the proper location and allow it to meet the unique requirements of a golfer using the interlocking grip method or the overlapping or ten finger grip method, for example, and thereby not currently being able maximize hand coordination throughout the golf swing. Embodiments overcome this oversight.

For example, although the basic interlocking grip method or the overlapping grip method is thought to connect the hands at the start of the swing, yet they suffer in allowing the golfer to place one's lead thumb in a consistent position. These methods obviously do not allow one's lead thumb to stay in place throughout the swing, without separation for most all golfers from those first learning the game to most all amateur golfers. The present invention provides solutions for those variations, and others, for superior effectiveness.

Likewise, there are slight variations as to the exact or preferred location of the lead thumb receiver portion 10, so the preferred embodiment allows for adjustability of the second thumb receiver 10 to accommodate these variations while still connecting the lead thumb to the front palm side 3 of the palm portion 2 of the opposite hand. The present invention provides solutions for those variations as well, for superior overall grip and golf club control.

One embodiment, for example, comprises a thumb receiver, grip enhancing means on the region of the glove 1 that resides generally between the first thumb receiver 10 and the pad of the first thumb receiver region on the palm side of the glove. The grip enhancing means of this embodiment provides the user with the ability to create a grip connection between the lead thumb and the opposite hand.

This and other embodiments now allow far greater connection, feel and coordination lost with prior art especially when gripping a golf club using the conventional glove or grip methods.

An example of a similar glove embodiment that will provide superior advantages over prior art in the sport of golf would be to provide a grip enhancing glove that allowed the lead thumb to be received in the opposite hand.

Users who prefer this embodiment will greatly benefit from significantly increased grip between both hands, for example, by providing grip support for the lead thumb with the strong hand's other thumb pad region, creating a far greater unified golf club swing.

The increased grip capabilities will provide a user with more stable grip capabilities to coordinate a golf swing and help minimize even a modest amount of unnecessary movement between both hands, and to adjust more properly his or her next golf swing. Embodiments of the present invention offer these significant improvements and solve an unrecognized problem in prior art.

As can be seen, among the benefits of the present invention include: the ability to offer greater golf consistency and accuracy by solving this previously unsolvable problem in prior art; a far more successfully coordinated golf swing, and; and heightened ability to better achieve a square clubface at impact with the golf ball.

The various embodiments will significantly improve one's ability to maintain both hands connection throughout the golf swing thereby overcoming the limitations of prior art golf gloves.

The added benefits from the present invention of course offer added capabilities and therefore new ways of swinging a golf club. For example, those using the interlocking grip method or overlapping grip method need not worry about their other fingers as the true connection comes from holding the lead thumb against the other hand's thumb pad, this takes our additional angles for the club to travel thereby increasing in the accuracy of the shot. Once the golfer places the glove 1 on the strong hand, the strong hand now has a second thumb receiver portion 10 for the lead hands thumb. As the golfer takes the club back, they maintain this connection pressure and maintain it throughout the swing so there is complete unison of the hands in motion.

In summary, many features can be used in conjunction with each other to uniquely solve problems that have up until now been unsolved, and some perhaps also unrecognized. These and other embodiments:
a) offer the ability to grip and maintain the grip as well as feel a sports device, such as a golf club;
b) provide a unique solution for users who desire better grip capabilities only in select areas;
c) offer a more stabilizing overall grip of an object by conveying thumb receiver to select location of the palm side of the hand portions of a glove;
d) provide grip enhancers along the connecting area between the thumb of the lead hand and the palm side of the opposite hand;
e) permit the ability to use a glove on a strong hand configured to meet the unique needs of a user's preferred golf grip, especially for those using an interlocking grip or overlapping grip method or ten finger grip;
f) improve performance in hand task execution by providing heightened hand coordination capabilities throughout a golf swing;
g) offer more control capabilities for the lead thumb and the palm side of the opposite hand, a valuable feature when impacting a golf ball with greater velocity;
h) allow more hand coordination by adjusting a grip enhancing means to match a preferred variation of the golf grip method
i) decrease the likelihood of golf ball side spin because of less chance of hand separation during a golf swing;
j) offer more control capabilities for the grip as a cohesive unit, a valuable feature when impacting a golf ball with greater velocity;
k) increase the possibility for a squarer golf clubface at impact with the golf ball thereby improving feel with the brain of the hands connected along with ball contact, trajectory and accuracy;
l) provide a much-improved method of playing the sport of Golf by using the proper grip technique, not just for the weak hand but also for the strong hand's as well, without limiting the feel and coordination requirements in a proper golf swing;
m) provide added grip stability for golfers with relatively smaller hands;
n) provide added grip stability for golfers with relatively weaker hands;
o) provide added control for golfers who desire a more unified hand grip on the golf club; and,
p) provide a solution for golfers who find their hands becoming separated during a golf swing.

These are among the many benefits of the present invention and are not to be construed as limitations of the benefits nor their legal equivalent.

Although the description of the present invention only discussed the sport of Golf, it is understood that other sports may benefit from connecting the hands as described.

Furthermore, only some embodiments have been discussed and in no way is intended to limit all the various embodiments and other embodiments that the present invention provides. Embodiments can of course be used by men and women, boys and girls, professional athletes, or amateurs, as well as by those whose dominant hand is the right hand or the left.

I claim:

1. A sports glove, having a glove body wherein said glove body has dorsal and palmar portions adapted to overlay a back and a palm of a wearer's hand respectively, wherein said dorsal and palmar portions have distal and proximal ends with a plurality of digital segments projecting from the distal end, wherein said glove provides a digital segment of the thumb that is adapted to enclose an entire thumb of the wearer and has a dorsal portion and a palmar portion, wherein said glove provides a digital segment of the forefinger that is adapted to enclose an entire forefinger of the wearer and has a dorsal portion, a palmar portion, a first side adjacent the wearer's thumb and a second side opposite said first side and adjacent a middle finger of the wearer's hand when the glove is worn; wherein said glove provides a digital segment of the middle finger that is adapted to enclose an entire middle finger of the wearer and has a dorsal portion and a palmar portion; wherein said glove provides a digital segment of the ring finger that is adapted to enclose an entire ring finger of the wearer and has a dorsal portion and a palmar portion, wherein said glove provides a digital segment of the pinkie finger that is adapted to enclose an entire pinkie finger of the wearer and has a dorsal portion and a palmar portion; and, wherein said glove further comprises a second thumb portion separated and spaced apart from said first open thumb portion, forming a six fingered glove, whereby the thumb and fingers of one hand of the wearer are inserted into the first open thumb portion and said open finger portions, and the thumb of the wearer's other hand is inserted into said second open thumb receiver portion of the glove, thereby stabilizing the wearer's manual grip of the golf club.

2. A glove for promoting the stable grip of a golf club handle, comprising:
said glove having an open proximal wrist portion connected to a front palm portion and a back dorsal portion, said glove having a distal array of open finger portions and a first open thumb portion,
a second open thumb receiver portion positioned on said front palm portion, said second open thumb receiver portion separated and spaced apart from said first open thumb portion, forming a six fingered glove, whereby the thumb and four fingers of one hand of the wearer are inserted into the first open thumb portion and said open finger portions, and the thumb of the wearer's other hand is inserted into said second open thumb receiver portion of the glove, thereby stabilizing the wearer's manual grip for the golf club handle.

3. The glove as in claim 2 wherein said second open thumb receiver portion being spaced apart and adjacent to said first open thumb portion are actually next to each other.

4. The glove as in claim 2 wherein said second open thumb receiver portion is a receiver for securing said thumb of the wearer's other hand to said glove.

5. The glove as in claim 2 wherein said second open thumb receiver portion is a closed sleeve.

6. The glove as in claim 2 wherein said second open thumb receiver portion is an open sleeve.

7. The glove as in claim 2 wherein the second open thumb portion is permanently attached to said glove.

8. The glove as in claim 2 wherein the second open thumb portion is removable.

9. The glove in claim 2 wherein the second thumb portion is a receiver loop for the opposite hands thumb portion.

10. The glove in claim 2, wherein the second thumb portion is a full thumb stall.

11. The glove in claim 2, wherein the second thumb portion is a partial thumb receiver.

12. The glove as in claim 2 wherein the second thumb portion comprises a long, tubular sleeve.

13. The glove as in claim 2 wherein the second thumb portion comprises a short, tubular sleeve.

14. The glove as in claim 2 wherein the second thumb portion comprises a medium length, tubular sleeve.

15. The glove as in claim 2 wherein the second thumb portion comprises a textured tubular sleeve.

16. The glove as in claim 2 wherein the second thumb portion comprises a plurality of loops.

17. The glove as in claim 16 wherein the second thumb portion comprises two loops.

18. The glove as in claim 2 wherein the location of said second open thumb portion comprises attachable inserts, which are removably affixed to the glove surface by forming a grip enhancing panel and applying the panel onto a portion of the glove, wherein said second thumb portion is removably affixed to said grip enhancing panel.

19. The glove as in claim 2 wherein said second thumb receiver is made of a stretchable fabric and in stretchable in axial length and/or diameter width.

20. The glove as in claim 2 wherein said second thumb receiver is made of a material from the group consisting of natural, leather, synthetic leather, rubber material, elastic material, knitted fabric, LYCRA®, wood cellulose based Rayon fabric, cotton, natural, synthetic or blends of natural and synthetic yarns, thermo-extruded material, thermoset rubbery material, thermoplastic elastomers, synthetic yarns, nylon, polyester, polyurethane yarns, SPANDEX®, stretchable fabric, mesh fabrics, recycled and flexible materials, cottons, polyester, fleece, rubbers, plastics, woven fabrics, non-woven fabrics, cloths, LYCRA, vinyl materials, NEOPRENE®Ms a neoprene material, COOL MAX® fabric, or wicking materials to wick moisture away form a user's skin, natural rubber latex, synthetic rubber nitrile, polyvinyl alcohol material, polyvinyl chloride, polyethylene, polyurethane, polyester/cotton blends, polyolefin fibers, or combinations thereof.

21. A method of training a player to stabilize and hold his or her hands upon a golf club handle prior to swinging the golf club for striking a golf ball while engaged in a golf sports activity, comprising the steps of:
providing the player with a glove having an open proximal wrist portion connected to a front palm portion and a back dorsal portion, said glove having a distal array of open finger portions and a first open thumb portion,
providing a second open thumb receiver portion to be positioned on said front palm portion, said second open thumb receiver portion being separated and spaced apart from said first open thumb portion,
forming a six fingered glove, whereby the thumb and four fingers of one hand of the wearer are inserted into the first open thumb portion and said open finger portions, and the thumb of the wearer's other hand is inserted into said second open thumb receiver portion of the glove, thereby stabilizing the wearer's manual grip for the golf club handle; and,
instructing the player to maintain said two-thumbed grip upon the golf club handle during the entire swinging of the golf club and striking the golf ball during the swinging of the golf club; and instructing the player to use his or her hands both to grip as well as feel the golf club throughout the golf swing;
whereby the handle of the golf club is stabilized prior to striking the golf ball, during the striking of the golf ball and during the follow-through portion of the player's swinging of the golf club.

22. A method of training a player to stabilize and hold his or her hands in a golf grip position while engaged in a golf sports activity, comprising the steps of:
providing the player with a glove having an open proximal wrist portion connected to a front palm portion and a back dorsal portion, said glove having a distal array of open finger portions and a first open thumb portion,
providing a second open thumb receiver portion to be positioned on said front palm portion, said second open thumb receiver portion being separated and spaced apart from said first open thumb portion,
forming a six fingered glove, whereby the thumb and four fingers of one hand of the wearer are inserted into the first open thumb portion and said open finger portions, and the thumb of the wearer's other hand is inserted into said second open thumb receiver portion of the glove, thereby stabilizing the wearer's manual grip for the golf grip position; and,
instructing the player to maintain said two-thumbed grip in a golf grip position.
